(19) United States
(12) Patent Application Publication
(10) Pub. No.: US 2011/0200764 A1
(43) Pub. Date: Aug. 18, 2011

(54) EZ Flesh

(76) Inventor: Kelly Lloyd Mann, (US)

(21) Appl. No.: 12/707,717

(22) Filed: Feb. 18, 2010

(51) Int. Cl. C08L 31/04

(52) U.S. Cl. 428/16; 524/563

(57) ABSTRACT

EZ Flesh, a melt-mold cosmetic skin composition for static human-like figures that includes thermoplastic polyamide adhesive, flocking* and a pigment*

Wax museums began displaying life-like human mannequins for the edification, and amusement of their patrons centuries ago. Since then, the theater, and motion pictures have necessitated making artificial body parts for certain scenes, or actions where a real person or actor might sustain injury. Aficionados of films and plays sometimes collect and display artificial figures, or heads, created to resemble their favorite characters, much in the way that wax museums display wax figures. These collector's mannequins, or display heads have traditionally been made of slush cast latex pieces, painted, and filled with expanded polyurethane foam. Occasionally these pieces are constructed of molded silicone, fiberglass, or rigid urethane, sometimes colored intrinsically, or painted.

The EZ Flesh material offers a more permanent , lower cost, and better looking alternative to the existing art.

EZ flesh is a melt-molded thermoplastic that has a relatively low melting point; Viscosity@250° (F.): (cps) 39,000@325° (F.): (cps) 10,000@375° (F.): (cps) 5,400. The Softening Point 176° F.: Open Time 45-65 seconds. A clear color, Slight odor, and an indefinite shelf life. The Flash Point is above 450° (F.) It may be melted on a stove top, or electric fry pan. Because there is no chemical reaction, or evaporation it sets quickly. It needs only to cool to become rigid. It has a skin-like transparency, and accepts diethelyne glycol based colors, powdered dyes, acrylic craft paint. The colors may be added when the material is molten.

When molten, it can be brushed or slushed into an open mold. Silicone molds, or any non-porous mold, treated with a wax, or oil, or silicone release. When removed from the mold, the cast piece may be painted with acrylic, vinyl, or solvent based paints. Its seams clean up with a hot knife, or seam tool. Separate castings can be melted together, and unlike wax—many adhesives stick, and hold well. Hair may be punched by conventional means, and lace hair pieces may be embedded into it.

This material does not yellow over time, does not dry out and crack, does not exude oils, does not become brittle, is colored intrinsically for a realistic skin-like translucency, and It may be re-melted and molded again, creating minimal material waste.

What is claimed is:

1. A new melt-molding material for the creation of superior lifelike mannequins, figures and body parts comprised of a hot melt adhesive (thermoplastic ethylene-vinyl acetate co-polymer; having a melting point greater than 200.degree. F.), with the addition of flocking to be used as pigment, and small amounts of other pigments.

2. The material has a skin-like translucency and color, due to the inherent translucency of the base material, and small amounts of pigment additives.

3. The material, when molten, may be shaped by introduction to a lubricated mold, via pouring, brush or pressure injection.

4. In thicknesses of .6700 to .25 of an inch, a curved molded shape (e.g. body part) will maintain its shape at a temp of 120° or lower without the use of a rigid substrate.

5. End users may re-melt the material, it repairs and joins easily, with a hot tool.
